(19) United States
(12) Patent Application Publication
(10) Pub. No.: US 2026/0009764 A1
(43) Pub. Date: Jan. 8, 2026

(54) ION MOBILITY SPECTROMETER, AND METHOD FOR ANALYSING SUBSTANCES

(71) Applicant: GOTTFRIED WILHELM LEIBNIZ UNIVERSITÄT HANNOVER, HANNOVER (DE)

(72) Inventors: Stefan ZIMMERMANN, BURGWEDEL (DE); Alexander BOHNHORST, HANNOVER (DE); Ansgar KIRK, HANNOVER (DE); Martin LIPPMANN, HANNOVER (DE); Anne ZYGMANOWSKI, HANNOVER (DE)

(21) Appl. No.: 18/992,428

(22) PCT Filed: Jul. 10, 2023
(86) PCT No.: PCT/EP2023/068990

§ 371 Date: Jan. 8, 2025

(30) Foreign Application Priority Data
Jul. 11, 2022 (DE) 10 2022 117 190.6

(51) Int. Cl. G01N 27/622

(52) U.S. Cl. CPC G01N 27/622

(57) ABSTRACT

The invention relates to an ion mobility spectrometer comprising the following features:
a) at least one ion packet provision device configured to provide packets of ions separated from one another in succession at time intervals,
b) an ion detector,
c) at least one drift chamber, through which the ions are guided over a predetermined distance in a drift direction to the ion detector in order to be discharged there.

The invention additionally relates to a method for analyzing substances by ion mobility spectrometry by means of an ion mobility spectrometer of the above-mentioned type.

The invention relates to an ion mobility spectrometer having the following features:
a) at least one ion packet provision device configured to provide packets of ions separated from one another in succession at time intervals,
b) an ion detector,
c) at least one drift chamber, through which the ions are guided over a predetermined distance in a drift direction to the ion detector in order to be discharged there.

The invention additionally relates to a method for analyzing substances by ion mobility spectrometry by means of an ion mobility spectrometer of the above-mentioned type.

An ion mobility spectrometer and a corresponding method for gas analysis are already known from DE 10 2013 114 421 B4.

The invention is based on the object of specifying an ion mobility spectrometer further improved with respect to the analysis options and a corresponding method.

This object is achieved in an ion mobility spectrometer of the type mentioned at the outset in that the ion mobility spectrometer has an ion modification area between the ion packet provision device and the at least one drift chamber, which has an input electrode arrangement on the side facing toward the ion packet provision device and an output electrode arrangement on the side facing toward the at least one drift chamber, wherein a modification chamber for accommodating ions is arranged between the input electrode arrangement and output electrode arrangement, wherein the ion modification area is configured to carry out one or more modifications on the ions located in the modification chamber. In this case, a modification is understood, for example, as a change of at least one physical and/or chemical property of the ions. The ions can be captured, for example, in the ion modification area. Capturing is not a modification. Capturing ions represents a significant difference from the prior art. The ion modification area is generally not used to discharge the ions, except if it is intended to be used as a filter. In general, the discharge is to take place only at the ion detector.

The invention has the advantage that due to the specified structure of the ion mobility spectrometer with the ion modification area, more extensive methods for analyzing, modifying, and/or influencing ions are made possible, using which the ions can once again be analyzed, modified, or influenced in another manner within the ion mobility spectrometer, in addition to the actual ion mobility spectrometry, for example, to obtain additional information and to further improve the selectivity, linearity, and/or sensitivity of the analysis.

Due to the modification of specific ions, specific ion species or ion packets, an additional change of those elements which go beyond the actual functionality of an ion mobility spectrometer is provided. The actual functionality of an ion mobility spectrometer is understood here as providing ion packets, emitting them in packets at time intervals into a drift chamber, moving the ions through the drift chamber, and detecting them at an ion detector.

When reference is made to a drift direction of the ions (or drift direction for short), this does not mean the respective current direction of the movement of ions or ion packets, but rather a permanently specified drift direction, in which the ions have to move through the drift chamber in order to reach the ion detector. When an axial direction is mentioned, this relates to the longitudinal axis of the ion mobility spectrometer or the respective part of the ion mobility spectrometer under discussion. The axial direction can in particular be parallel to the drift direction.

The at least one drift chamber can be arranged between the ion packet provision device and the ion detector viewed in the drift direction. The ion modification area can be located behind the ion packet provision device and in front of the at least one drift chamber in the drift direction of the ions. In the ion mobility spectrometer according to the invention, it is important that the ions have already covered a certain drift distance before entering the ion modification area. This can also only be the short distance from the ion packet provision device into the ion modification area. Or in other words—the ion source is not located in the ion modification area. The ion mobility spectrometer can have still further components in addition to the above-mentioned components, for example, an ion gate arranged in the drift direction behind an ion source of the ion packet provision device and in front of the ion modification area and/or an additional drift chamber arranged behind the ion packet provision device or behind the ion gate and in front of the ion modification area.

According to an advantageous embodiment of the invention, it is provided that the ion packet provision device has a cyclically operated ion source and/or a continuously operated ion source. With a cyclically operated ion source, the ion packets are provided in packets at time intervals already due to the functionality of the ion source. In this case, a downstream ion gate can be omitted. A continuously operated ion source continuously emits ions, as the name already says.

According to an advantageous embodiment of the invention, it is provided that the ion packet provision device has a cyclically operated ion gate. The ion gate can be designed, for example, as a shutter, e.g., as a field switching shutter, Bradbury-Nielsen shutter, Tyndall-Powell shutter, or tristate shutter. The ions provided by the ion source are emitted in packets by way of such a cyclically operated ion gate, i.e. there is a pause between the emission of one ion packet and the emission of the next ion packet, in which no ions are emitted. The input electrodes of the ion modification area and the electrodes of the shutter can advantageously be the same, i.e. the shutter can be integrated into the input electrode arrangement. This saves grid electrodes and thus reduces the complexity and ion losses.

According to an advantageous embodiment of the invention, it is provided that a supply connection is present at the ion modification area, which is configured to introduce at least one further substance, in particular a gaseous substance, into the modification chamber from the outside. This has the advantage that a further substance can be introduced directly into the modification chamber, where it can react with the ions located therein. By means of such an additional substance, for example, chemical reactions can be carried out in the modification chamber which are advantageous for the further analysis. A cluster formation of ions by such additional substances can also be promoted. In addition, it is possible to supply thermal energy by way of the introduced gas, for example, if hot gas is introduced. A heater can therefore also be present on the supply line for heating the gas.

The ion mobility spectrometer can have a first modification electrode arrangement, by which an electric field parallel to the drift direction of the ions, for example, a field in the axial direction, can be generated in the modification chamber. The first modification electrode arrangement can have one or more electrodes which are arranged in the modification chamber and/or electrodes which border the modification electrode arrangement in the direction of the input electrode arrangement and/or the output electrode arrangement. The first modification electrode arrangement can also be entirely or partially formed by one or more electrodes of the input electrode arrangement and/or the output electrode arrangement.

According to one advantageous embodiment of the invention, it is provided that a first modification electrode arrangement is present in the modification chamber, which has at least one electrode spaced apart from the input electrode arrangement and output electrode arrangement, wherein the modification chamber is divided by the first modification electrode arrangement into at least one first partial chamber facing toward the input electrode arrangement and at least one second partial chamber facing toward the output electrode arrangement. Even more electrodes of the first modification electrode arrangement and even more partial chambers are also possible. This has the advantage that different modifications can be carried out on the ions in the first and the second partial chamber. Moreover, an electric field parallel to the drift direction of the ions can be generated in the modification chamber by the first modification electrode arrangement. In this way, a targeted further transport of the ions in the drift direction can be carried out by the modification electrode arrangement, but also a reduction of the drift speed in the drift direction, up to a reversal of the drift direction such that the ions move in the direction of the input electrode arrangement again.

According to an advantageous embodiment of the invention, it is provided that a second modification electrode arrangement is present at the ion modification area, by which an electric field orthogonal to the drift direction of the ions can be generated in the modification chamber. For example, the second modification electrode arrangement can have divided ring electrodes or partial ring electrodes, which only consist of opposing surfaces, i.e. they do not extend fully around the circumference of the ion modification area. This has the advantage that the ions can also be subjected to electrical fields acting orthogonally to the drift direction, in particular alternating fields. The possibilities for modification of the ions are substantially expanded in this way. In particular in combination with the first modification electrode arrangement, it is possible to generate both axial and orthogonal electric fields, also combined with one another, in the ion modification area.

The object mentioned at the outset is additionally achieved by a method for analyzing substances by ion mobility spectrometry by means of an ion mobility spectrometer of the above-explained type, wherein the ions are modified in the modification chamber by one, multiple, or all of the following types of modification I), II), III), IV), V), before they are moved through the drift chamber to the ion detector:
I) displacing at least one species from the ions present in a direction deviating from the drift direction,
II) reducing or increasing the drift speed of at least one species from the ions present in the drift direction or displacing at least one species from the ions present in the drift direction,
III) reducing or dissolving the cluster formation of ions and molecules,
IV) fragmenting ions,
V) promoting chemical reactions and/or cluster formation of the ions.

It is to be noted that “displacement” is always referred to here in general, even if this effect is compensated for by a constant field.

In this way, diverse modifications can be performed on the ions, by which the ions can be analyzed once again in addition to the actual ion mobility spectrometry. Additional information can be obtained in this way. It is also possible to improve the selectivity, linearity, and sensitivity of the analysis.

It is to be noted that all modifications are used to a) change the ion mobility of individual ion species or b) shorten or lengthen the covered drift distance of individual ion species. The modification is only then meaningfully measurable in IMS.

In modification type I), for example, a displacement of at least one species from the ions present of different ion species can take place in a direction deviating from the drift direction. It is also conceivable to implement the method with only one ion species present.

In modification type II), for example, operation with capturing of the ions can be executed, in which the ions are shifted closer to the ion detector or farther away from it. The time until they reach it thus changes.

In modification type III), for example, a cluster formation of ions can be dissolved in such a way, for example, by supplying additional energy to the ions via electrical fields, that ions and molecules joined together to form a cluster are divided into individual ions or smaller clusters. In contrast, the fragmenting of ions mentioned in modification type IV) means breaking up of ions into individual chemical elements or partial ions. In this case, for example, the chemical bonds within ions can be broken.

According to one advantageous embodiment of the invention, it is provided that one, multiple, or all of modification types I), II), III), IV), V) are at least partially carried out by generating an electrical alternating field, in particular an asymmetrical or symmetrical alternating field, in the modification chamber. In this way, for example, targeted displacement, dissolving of clusters, or fragmenting of ions can be achieved very efficiently.

According to one advantageous embodiment of the invention, it is provided that to prepare for the modification of ions in the modification chamber, in a first step, initially in the ion modification area an electrical field, for example, in the drift direction, having a constant component is generated, which is sufficient to move modified ions from the direction of the input electrode arrangement into the modification chamber, and then, when sufficient ions are located in the modification chamber, in a second step
the constant component of the electrical field is reduced to zero or
by adjusting the constant component of the electrical field, a movement of at least one ion species to be modified, arising due to a superimposed electrical alternating field in the modification chamber, is canceled out or
by adjusting the constant component of the electrical field, an average movement of all ion species arising due to a superimposed electrical alternating field in the modification chamber is minimized.

In this way, the ions can be held for a nearly freely settable time in the modification chamber and modified there. The modification can be carried out here in the second step according to one, multiple, or all of modification types I), II), III), IV), V). If an electrical alternating field is used, it is also possible to select the time so that a whole number of full cycles of the alternating field is run through. This is not possible if the ions move at their normal drift speed through the modification area, since then different ion species have different dwell times.

The time for which the ions are held in the modification chamber can be predetermined or defined depending on events during the performance of the analysis. After the above-mentioned two steps, it is reasonable to carry out a third step in which, in the ion modification area, an electrical field having a constant component is then generated, which is sufficient to move the modified ions in the direction of the output electrode arrangement out of the modification chamber and transfer them into the drift chamber following in the direction of the ion detector.

According to an advantageous embodiment of the invention, it is provided that one, multiple, or all of modification types I), II), III), IV), V) are at least partially carried out by heating the interior of the modification chamber and/or the ions located therein. Additional energy can be supplied to the ions located in the modification chamber by the heating, by which, for example, a reduction or dissolution of the cluster formation of ions, a fragmentation of ions, or the promotion of chemical reactions and/or cluster formation of ions can be carried out. The heating can be carried out by means of a heating device, for example. The heating device can be part of the ion mobility spectrometer or can be designed as an external heating device. The heating device can be supplemented in addition to the energy supplied by the electrical fields. The advantage of the invention is that electrical fields can be adjusted much faster than conventional heating methods.

According to one advantageous embodiment of the invention, it is provided that one, multiple, or all of modification types I), II), III), IV), V) are at least partially carried out by adding a further substance, in particular a gaseous substance, through the supply connection into the modification chamber. Further modifications can be performed on the ions by the addition of such a further substance, in particular by chemical reactions.

According to an advantageous embodiment of the invention, it is provided that a substance to be analyzed by ion mobility spectrometry is supplied as a further substance, which is provided by the ion packet provision device and ions transported into the modification chamber form analyte ions to be analyzed. Accordingly, the actual analyte ions to be analyzed can first be produced in the ion modification area and do not have to be provided or at least do not have to be provided completely by the ion source. In this way, the analysis options of an ion mobility spectrometer are expanded to a large number of further substances, which were not analyzable in previous ion mobility spectrometers.

It is also advantageous in all of these methods to compare modified and unmodified spectra, thus not always to modify them. According to an advantageous embodiment of the invention, it is therefore provided that ion mobility spectra with and without modification of the ions in the modification chamber are alternately recorded. For example, ion mobility spectra with and without modification of the ions can always be recorded alternately. The alternation can also be carried out at other intervals, for example, regularly or irregularly.

The invention will be explained in more detail hereinafter on the basis of exemplary embodiments using drawings.

In the figures

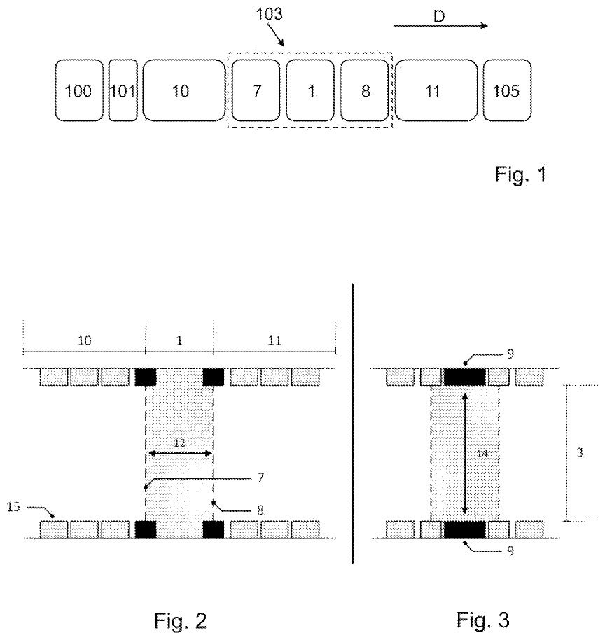

FIG. 1 shows an ion mobility spectrometer in a very schematic representation,

FIGS. 2 to 9 show embodiments of the ion modification area of the ion mobility spectrometer according to FIG. 1,

FIG. 10 shows waveforms of electrical fields which can be generated using the ion modification area according to FIG. 9,

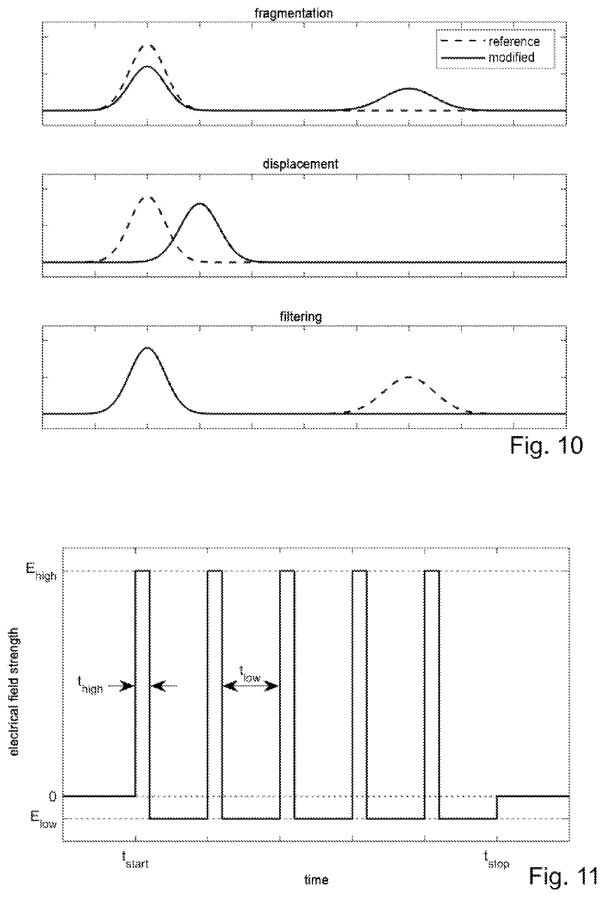

FIG. 11 shows a waveform of an electrical field for the modification,

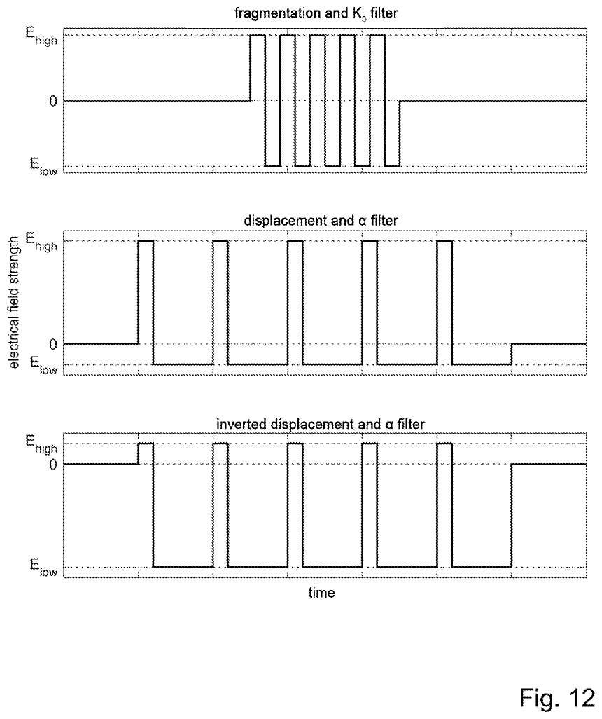

FIG. 12 shows modification options of ions in the ion modification area.

FIG. 1 shows a block diagram of an ion mobility spectrometer (IMS) having an integrated structure for modifying ions in the form of an ion modification area 103. The IMS has an ion source 100, an ion gate 101, the ion modification area 103, a drift chamber 11, and an ion detector 105. Optionally, an additional drift chamber 10 can also be present after the ion gate 101 and before the ion modification area 103. The arrangement of the individual elements is variable, wherein the ion source 100, possibly with the ion gate 101, always forms the beginning and the ion detector 105 forms the end. An arbitrary arrangement of drift chambers or the ion modification area 103 can be advantageous in between. The ion source 100 and the ion gate 101 together form the ion packet provision device. With a cyclically operated ion source 100, the ion gate 101 can be omitted, so that the ion packet provision device then only has the cyclically operated ion source 100.

IMS separate and characterize ions on the basis of their movement through a neutral gas under the influence of an electrical field. The ions move at a characteristic drift speed, as shown in FIG. 1, from the ion source 100 to the ion detector 105, wherein the drift speed depends via the ion mobility on the electrical field strength within the respective drift areas. The ions move here, for example, through the drift chamber 11 with a drift direction D.

Due to a coupling with a high-efficiency ionization at atmospheric pressure, ultrasmall concentrations of substances can be discovered on the basis of the signals at the ion detector 105. However, the pure separation via the ion mobility or a single-stage ionization is often not sufficient to achieve the desired separating performance, selectivity, linearity, or sensitivity. Therefore, a structure or a method for analyzing, modifying, or influencing ions is to be provided here, using which the ions can once again be analyzed, modified, or influenced in another manner within the IMS, in particular in the ion modification area 103, in order to obtain additional information, selectivity, or sensitivity. All possible influences of the ions are summarized hereinafter under the generic term “modification”, in order to simplify the language. A modification refers here to a change of any type in relation to a reference spectrum which was recorded without a modification of the ions. For example, a spectrum with and without modifications can always be recorded alternately, so that the effect of the modification can be measured by differences between the two spectra (as illustrated in FIGS. 10).

The ion modification area 103 consists of an input electrode arrangement 7 having one or more input electrodes, an output electrode arrangement 8 having one or more output electrodes, and one or more modification chambers 1, which extend, viewed in the drift direction D, from the last electrode of the input electrode arrangement 7 to the first electrode of the output electrode arrangement 8. In the simplest case, both the input electrode arrangement 7 and the output electrode arrangement 8 are each formed by a single grid, wherein significantly more complex embodiments can also be advantageous, as shown later. Depending on the arrangement, the ion modification area 103 can also contain multiple modification chambers or partial chambers separated from one another by additional electrodes.

Input electrode arrangement 7, modification chamber(s) 1, and output electrode arrangement 8 are configured here to implement the following method for modification of the ions: In a first step, in the ion modification area 103, an electrical field having a constant component is generated which is sufficient to move the ions to be modified from the direction of the input electrode arrangement 7 into the modification chamber 1. In a second step, the constant component is set to zero or to a value which balances out a movement arising due to an electrical alternating field of at least one ion species to be modified or to a value which minimizes the average movement of all ion species arising due to an electrical alternating field on average. In this way, the ions are modifiable for a nearly freely settable time. This can be predetermined or determined during the execution, as explained later. In the third step, in the ion modification area 103, an electrical field having a constant component is generated, which is sufficient to bring the modified ions in the direction of the output electrode arrangement 8 out of the modification chamber 1.

In the second step, ions can be modified according to one or more of the following options or it can be checked whether or not modifications occur under certain circumstances:
1. At least one ion species is displaced due to its field-dependent ion mobility by an asymmetrical alternating field or this displacement is compensated for by adjusting the constant field.
2. Ions are fragmented by an asymmetrical or symmetrical alternating field.
3. Ions are fragmented by heating in the analysis area or hot gas.
4. Reactions or cluster formation take place due to the addition of further substances.

With reference to point 1, it is to be noted that reference is always made here in general to “displacement”, even if this effect is compensated for by a constant field. In this case, the constant field used for the compensation is a measure of the field-dependent ion mobility. In addition to the preceding points, the second step can also include waiting times without further modification, so that, for example, excited reactions can run to the end.

The method is advantageously carried out only with a part of the recorded spectra, so that a comparison between spectra without modification (reference spectrum) and spectra with modification (modified spectrum) can take place.

### Mechanical Structure

The structure according to the invention is typically used as part of an ion mobility spectrometer, i.e. an ion source 100 and at least one first drift chamber 10 are located in front of the input electrode arrangement 7 and at least one second drift chamber 11 and an ion detector 105 are located behind the output electrode arrangement 8. The first drift chamber 10 can also be omitted, however, so that all ions injected from the ion source 100 are analyzed or modified. The ion source 100 can adopt all forms known from ion mobility spectrometry in this case, for example, a reaction chamber having Bradbury-Nielsen, Tyndall-Powell, three-grid, or tristate ion gate or field switching ion gate having integrated field-free reaction chamber.

FIG. 2 shows an embodiment of the ion modification area 103, in which a first drift area 10 is provided in the ion modification area 103 by the input electrode arrangement 7. A second drift area 11 is provided in the ion modification area 103 by the output electrode arrangement 8. A first axial modification chamber 1, which is formed between the last electrode of the input electrode arrangement 7 in the drift direction D and the first electrode of the output electrode arrangement 8, is located between the first and the second drift areas. These electrodes form a first modification electrode arrangement, by which an electrical field 12 active in the axial direction can be generated in the modification chamber 1. A displacement, a declustering, and/or fragmentation of ions can thus be generated, for example, by axial alternating fields in the ion modification area 103.

FIG. 3 shows an embodiment of a second modification electrode arrangement having electrodes 9, by which an electrical field 14 orthogonal to the drift direction of the ions can be generated in the modification chamber 1. A declustering and/or a fragmentation of ions can be generated by orthogonal alternating fields in the ion modification area.

For example, the electrodes of the input electrode arrangement 7 and/or the output electrode arrangement 8 are formed by grids, since these influence the electrical field over the entire diameter of the ion modification area, independently of the selected diameter of the ion modification area. However, other electrode shapes can also be used, for example, ring electrodes 15, divided ring electrodes, or partial ring electrodes 9, which only consist of opposing surfaces. It is to be noted in this case that, as shown in FIG. 3, only axial alternating fields permit both displacement and declustering and fragmentation, while orthogonal alternating fields only enable declustering and fragmentation.

According to one advantageous embodiment, the field in the ion modification area, in particular upon the use of grids as electrodes, is only generated by the respective inner electrodes of input electrode arrangement 7 and output electrode arrangement 8, as shown in FIG. 2. It is also possible, as shown in FIG. 3, to generate the alternating field in the ion modification area only or primarily via divided or partial ring electrodes 9 as modification electrodes.

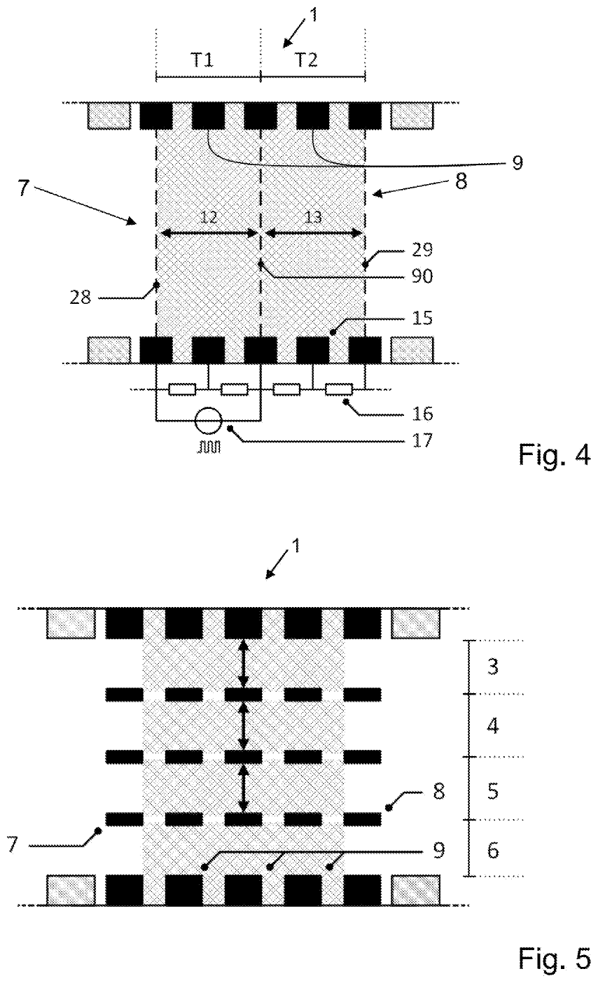

FIG. 4 shows an embodiment of a first modification electrode arrangement, in which at least one electrode 90 is arranged spaced apart from both the input electrode arrangement 7 and the output electrode arrangement 8, for example, in the center of the modification chamber 1 or also off-center. The modification chamber 1 is divided by the electrode 90 into a first partial chamber T1 and a second partial chamber T2. The input and output electrode arrangements 7, 8 each consist of a grid. Due to this structure, it is possible to generate electrical fields of different signs simultaneously in the first partial chamber T1 and the second partial chamber T2 using only one AC voltage source 17.

FIG. 4 moreover shows that electrodes arranged one behind another can be connected to one another via a resistive voltage divider 16. A voltage source 17, for example, an AC voltage source, can be connected to the voltage divider 16 or to specific electrodes.

As shown in FIG. 4, additional ring electrodes 9 are also possible in the modification chamber 1 or in the first partial chamber T1 and/or the second partial chamber T2, the potentials of which are set, for example, via the voltage divider 16 between the respective inner electrodes 28, 29 of input electrode arrangement 7 and output electrode arrangement 8. By way of a voltage divider, these ring electrodes 9 then follow the course of the electrical potential desired by virtue of the combination of constant fields and alternating fields in the ion modification area 103. The ion modification area 103 can also contain further grids.

A further modification electrode 90 is advantageously present between the first partial chamber T1 and the second partial chamber T2, at which the voltage of the voltage source 17 for generating the alternating field is applied, so that an electrical field 12 exists in the first partial chamber T1 and an electrical field 13 with the opposite sign exists in the second partial chamber T2. In this way, the resulting displacements of ions have different signs, which permits a displacement in both directions using only one AC voltage source. If ring electrodes are used in this case, their voltage dividers can also be connected to the modification electrode 90 and the respective inner electrodes 28, 29 of input electrode arrangement 7 and output electrode arrangement 8. The AC voltage source can be implemented, as shown later, for example, by DC voltage sources and switches.

As already mentioned above, the electrodes of the input electrode arrangement 7 and output electrode arrangement 8 are often formed by grids, since these influence the electrical field independently of the selected drift area diameter over the entire diameter. In the case of small diameters at the point of the ion modification area 103, for example, at most five times, better at most two times or equal to or less than the dimension of the ion modification area in the drift direction D, ring electrodes are nearly as efficient as grids. In this case, ring electrodes or divided ring electrodes or partial ring electrodes can also be used for all electrodes of the input electrode arrangement, the ion modification areas, and the output electrode arrangement.

It is advantageous for this purpose in particular, as shown in FIG. 5, to create a structure consisting of multiple parallel channel-type structures for modification of ions, each of which contains a rear electrode 7 of the input electrode arrangement 7, one or more modification chambers 3, 4, 5, 6, and a front electrode 8 of the output electrode arrangement 8. The individual modification chambers 3, 4, 5, 6 have smaller diameters here than the original modification chamber 1, so that the efficiency of the ring electrodes is greater. In this case, a greater electrical constant field can advantageously be used in the first step in the input electrode arrangement 7 than in the area in front of it, in order to focus the ions into the modification chambers 3, 4, 5, 6 and avoid losses.

FIG. 5 illustrates an embodiment having four structures located in parallel for modifying ions (shaded). Due to the small diameter of each structure for modifying ions, the electrodes of input electrode arrangement 7, modification chambers 3, 4, 5, 6, and output electrode arrangement 8 can be designed as ring electrodes or partial ring electrodes. Instead of an axial electrical alternating field, an orthogonal electrical alternating field between the modification electrodes 9 located parallel to one another of the modification chambers 3, 4, 5, 6 can advantageously be used for the modification in this arrangement.

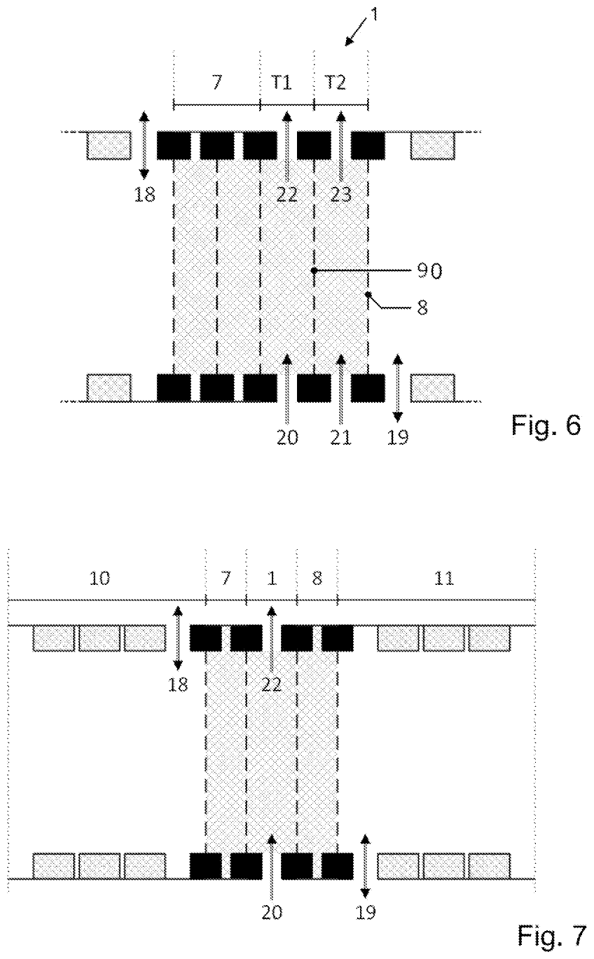

FIG. 6 shows an embodiment of an ion modification area 103, in which additional substances or hot gas can be introduced into the modification chamber 1 or the partial chambers T1, T2 by gas inlets 20, 21 for a further modification in the ion modification area 103. Moreover, outlets 22, 23 for the direct discharge of the substances or gases supplied through the gas inlets 20, 21 can also be present directly in the ion modification area 103. The additional inlets or outlets 18, 19 can be used, for example, for the supply or discharge of the drift gas. They can also be arranged inside the input electrode arrangement 7 and/or the output electrode arrangement 8.

FIG. 6 shows a detail of an IMS having a structure for modification of ions (shaded), wherein the input electrode arrangement 7 is embodied as a three-grid ion gate. The two partial chambers T1, T2 of the modification chamber 1 are divided from one another by a modification electrode 90. The output electrode arrangement 8 shields the ion detector from the electrical alternating fields in the partial chambers T1, T2. Additional substances or hot gas for a further modification of the ions can be introduced into the partial chambers T1, T2 through the gas inlets 20, 21. The inlets and outlets 18, 19 are used for the supply and discharge, respectively, of the drift gas and can also be located inside the input or output electrode arrangement.

According to an advantageous embodiment, parts of the input electrode arrangement or the entire input electrode arrangement 7, as shown in FIG. 6, form an ion gate, in particular if a first drift area is present. It is even more advantageous to use the variable potential of the modification electrode 90 to construct an ion gate. Only a part of the ions can thus be allowed for the modification. All known ion gates can be used here, such as Bradbury-Nielsen, Tyndall-Powell, three-electrode, or tristate ion gates.

The use of a three-electrode or tristate ion gate, the middle electrode of which is formed from structures isolated from one another, for example, in the case of a grid from rods or in the case of ring electrodes from a divided or partial ring electrode, is particularly advantageous. Alternatively, if grids are used, at least two of the grids can also be displaced in relation to one another orthogonally to the drift direction. In this way, an orthogonal electrical constant field or alternating field can be used in the closed state in addition to the normal, closed electrical field in the longitudinal direction, in order to deliberately eliminate non-transmitted ions.

According to an advantageous embodiment, parts of the output electrode arrangement or the entire output electrode arrangement 8 also form an ion gate. Ions inadvertently emerging from the modification chamber 1 during the modification can thus be discharged and removed from the modified spectrum. The same design variants as in the input electrode arrangement 7 can be used in this case.

According to an advantageous embodiment, at least the last electrode of the output electrode arrangement 8 in the drift direction D is at a fixed potential in order to shield the ion detector 105 from AC voltages and/or voltage pulses in the ion modification area 103.

FIG. 6 shows additional, optional gas inlets 20, 21 in the first and second partial chambers T1, T2 and gas outlets 22, 23 in the first and second partial chambers T1, T2, in order to supply hot gas for heating the ion modification areas or to supply substances for further reactions in the ion modification area 103.

FIG. 7 shows a variant of the ion modification area 103, in which only one gas inlet 20 and one gas outlet 22 are each present in the modification chamber 1.

According to an advantageous embodiment, the partial chambers T1, T2 have both dedicated gas inlets 20, 21 and dedicated gas outlets 22, 23, so that the gas deliberately only flows through the respective partial chambers T1, T2. Such gas inlets 20, 21 and gas outlets 22, 23 can also be present in an undivided modification chamber, however. In particular a gas guidance similar to the gas guidance described in DE 10 2019 125 482 for field switching ion gates is suitable for this purpose. The modification steps can be carried out by a laminar gas flow only through the respective partial chambers T1, T2, without influencing the remainder of the IMS.

According to an advantageous embodiment, during the second step, the one or two electrodes of the input electrode arrangement 7 and/or the output electrode arrangement 8 closest to the modification chamber 1 are at the same potential in order to reduce field breakthroughs from the outside. According to an advantageous embodiment, all electrodes of the input electrode arrangement and/or the output electrode arrangement are at the same potential. According to an advantageous embodiment, drift rings outside the analysis area are also placed at the same potential as the respective end of the analysis area during the second step, advantageously over at least one and one-half times, two times, or three times the diameter of the drift tubes.

Advantageous widths of the ion modification area 103 or the modification chamber 1 are 1 mm, 2 mm, 3 mm, 4 mm, 5 mm, i.e. their dimension in the drift direction D. If the modification chamber 1 has multiple partial chambers T1, T2, the dimensions named apply for the respective partial chambers. According to an advantageous embodiment, the distances among the electrodes of the input electrode arrangement 7 and among the electrodes of the output electrode arrangement 8 are less than the width of the ion modification area 103 or the modification chamber 1. It can be advantageous here to select the distance between the two electrodes of the input electrode arrangement closest to the modification chamber 1 and/or the distance between the two electrodes of the output electrode arrangement closest to the modification chamber 1 so as to be equal to or at least within 20% of the width of the modification chamber, in order to avoid electrical breakthroughs. According to an advantageous embodiment, the width of the modification chamber is m times the spatial extension of the ion packet of the ion species to be analyzed. In this case, m is supposed to be, but does not have to be, greater than 1, better greater than 2. The spatial extension of the ion packet can be reduced or increased by the ratio of the electrical field strength at a field transition, for example, between the area before the input electrode arrangement and the area inside the input electrode arrangement, in order to adjust m.

According to an advantageous embodiment, the surfaces of the electrodes subjected to the high electrical field strengths, for example, the input electrode arrangement, the output electrode arrangement, and the interposed electrodes, have a high work function in order to prevent electrical discharge between the electrodes.

### Modification Modes

According to an advantageous embodiment, a reduced field strength of the electrical alternating field greater than 10 Td, 30 Td, 60 Td, 90 Td, or 120 Td is used to displace or fragment ions. This can be varied to achieve different displacements or fragmentations.

From the displacement at different reduced field strengths, an analysis can take place either via the constant field necessary to compensate for the movement or via the displacement relative to another known ion species. The so-called alpha function, the change of the ion mobility with the reduced field strength, can also be determined therefrom. The absence of a displacement at a specific field strength can also offer information here. According to an advantageous embodiment, a standard having a known change of the ion mobility with the reduced field strength is used to determine the displacement. It is particularly advantageous if this displacement of the standard is negligibly small. The displacement can also be used to eliminate one or more undesired ion species from the ion modification area by skilled selection of the constant field, while the movement of one or more other ion species is compensated for to such an extent that they do not reach the electrodes.

An analysis can also take place from the fragmentation at different reduced field strengths. In particular, in this case the ratios of one or more fragments to the original ion set can be analyzed after separation in the second drift chamber. The absence of a fragmentation at a specific reduced field strength can also offer information here. So-called thermometer ions can be used as a standard in this case, which have a bond that breaks up at a known energy. According to an advantageous embodiment, a substance can also be added in the reaction chamber, in the first drift chamber, or also in the ion modification area itself, which forms clusters with one or more ion species so that the dissociation of these clusters at different reduced field strengths can be analyzed. This is helpful in particular in the analysis of ions which cannot be fragmented due to excessively high stability.

Undesired clusters can also be dissociated extremely efficiently by the ion modification area. This is the case, for example, if the ionization source is an electrospray ionization (ESI). The clusters resulting in this case made up of target substances and solvents can be dissociated in the ion modification area, so that thereafter only the desired ion species still remain and can be transferred for separation into the drift chamber located behind the ion modification area.

In particular, a combination of, for example, displacement and fragmentation is also possible, for example, in order to analyze multiple ion species having equal ion mobility at low reduced field strengths. All except one ion species can thus initially be eliminated here, for example, using an alternating field suitable for displacement during the second step via the displacement, then the remaining ion species can be fragmented using an alternating field suitable for fragmentation and then the resulting fragments can be separated in the second drift chamber. This procedure can be repeated for all ion species at various reduced field strengths for fragmentation in order to obtain a comprehensive picture.

The energy transferred to the ions by highly reduced electrical field strengths depends according to the Wannier equation on the square of the ion mobility. A fragmentation via highly reduced electrical field strengths alone is therefore only efficient for ions of high mobility. In order to assist the fragmentation or even fragment directly, hot gas can therefore be conducted through the ion modification area or the ion modification area can be heated in another way, locally limited to the ion modification area. The temperature is particularly advantageously selected here so that the resulting energy is just below the fragmentation energy of the ion species to be analyzed which is easiest to fragment. An analysis of the unmodified ion species is thus still possible without electrical alternating field and the energy range settable by the electrical alternating field is maximal. Heating the entire IMS is also possible in principle, but reduces the achievable resolution, possibly results in fragmentation in the drift chambers, and restricts the material selection in the design depending on the temperature.

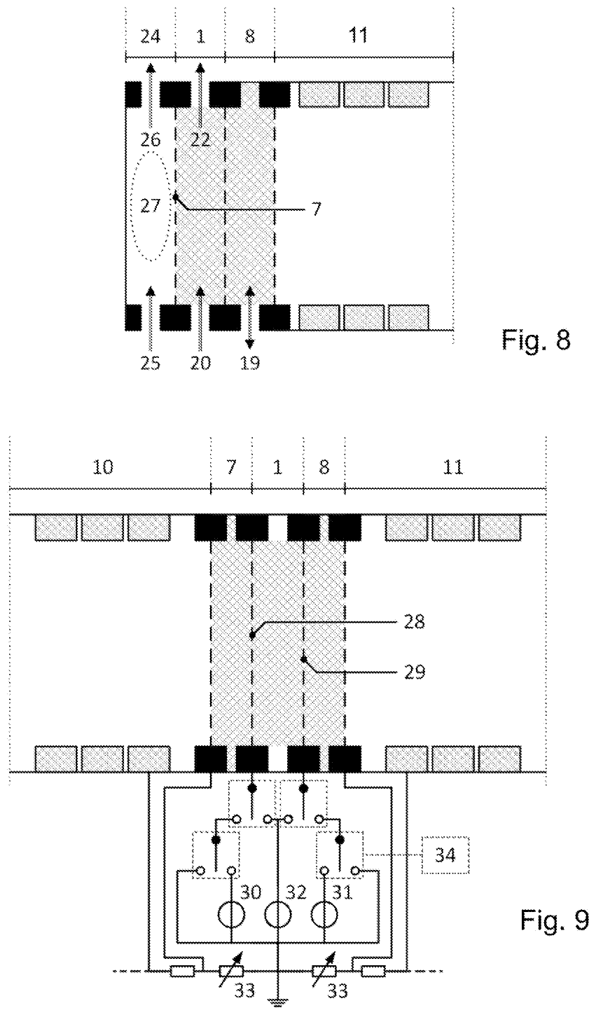

FIG. 8 shows a detail of an IMS having a field switching ion gate having integrated reaction chamber 24, a structure for modifying ions (shaded, ion modification area 103), and a drift chamber 11. The gas inlets 20, 25 and gas outlets 20, 24 are located so that gas compositions different from one another prevail during the formation of the reactant ions in the area 27 and in the modification chamber 1. The drift gas in the drift chamber 11 can advantageously be supplied or discharged through the gas inlet or outlet 19 in the outlet electrode arrangement 8. The output electrode arrangement 8 is used here, similarly as in DE 10 2018 107 909 A1, as a field-free area for shielding during the modification.

The substances added in the ion modification area 103 through the gas inlet 20 can also contain the actual sample, as illustrated in FIG. 8. In this way, only reactant ions are present in the ion source and possibly the first drift chamber 10 (not shown in the figure). This has a variety of advantages:

First, the reactant ions can react over a longer period of time in the ion source, for example, until their equilibrium state and can then first be brought into contact with the analyte molecules in the ion modification area. In this way, intermediate products of the formation of the reactant ions do not take part in the formation of the analyte ions, which is advantageous in particular upon the use of so-called dopants, i.e. substances which are supposed to influence the formation of the reactant ions. In addition, the reaction time for the formation of the reactant ions and the reaction time for the formation of the analyte ions can be set independently of one another. This in particular permits extremely short reaction times to increase the linear range and to minimize competing reactions.

Second, due to the first drift chamber, in particular in combination with an ion gate in the input electrode arrangement, even upon the formation of multiple reactant ion species, only one of these species can deliberately be selected as a reactant ion for the formation of the analyte ions. Only reactant ions of one polarity also participate in the reactions, so that recombination as a loss mechanism of the analyte ions is eliminated.

Third, the reactant ions can be influenced by the alternating field during the formation of the analyte ions. Water clusters can thus be broken up, for example, in order to increase the reactivity of the reactant ions.

### Waveform and Electrical Circuitry

According to one advantageous embodiment, an alternating field consisting of a short pulse, for example, in rectangular form, having high field strength in one of the two directions in combination with a longer period of lower field strength in the opposite direction is used to displace the ions. The short pulse particularly advantageously makes up less than 30%, less than 20%, or less than 10% of the period duration. According to an advantageous embodiment, an alternating field consisting of pulses of similar height and length in both directions (high and low level) is used for the fragmentation of the ions. An alternating field in which each direction makes up 50% of the period duration is particularly advantageously used. In general, longer pulses result in stronger fragmentation, since the ion only absorbs sufficient energy over a longer period of time and also distributes it over its inner states. A targeted reduction of the pulse duration by way of a shorter period duration or a smaller proportion of the pulse can therefore be helpful in order to achieve displacement without fragmentation.

All voltages described as pulses can be approximated here by similar functions, for example, trapezoidal voltages, exponential curves as with a back-overshoot generator, for example, or the superposition of one or more sinusoidal oscillations.

According to one advantageous embodiment, parameters, such as reduced field strength, period duration, proportion of the pulse in the period duration, or time until the second step, are adapted so that none of the ion species to be analyzed and their product ions are discharged on the input electrode arrangement or the output electrode arrangement or the interposed electrodes during the modification.

Three points are relevant here in particular. First, to select the time until the second step so that the ion packet of the ion species to be analyzed is placed as symmetrically as possible between the respective inner electrodes 28, 29 of input electrode arrangement 7 and output electrode arrangement 8 in order to maximize the possible amplitude of the movement in the alternating field. Second, to select the period duration so that these electrodes are not yet reached by the ion packet or are not yet reached by a significant percentage of the ions during the movement in the alternating field. Third, to select the total duration of the modification, thus the duration occupied by the second step, so that the diffusion of the ion packet does not yet result in reaching the electrodes. In particular the last two points are to be considered in combination for this purpose.

According to an advantageous embodiment, the optimum time until the second step is calculated based on the drift time in the reference spectrum or determined by measurement using a standard or experimentally determined via a variation of the time until the second step and selection of the value having the lowest losses. For the experimental determination, the other parameters have to be selected so that losses already occur. Alternatively, the optimum time can also be determined by switching the ion gate formed by the input electrode arrangement and the ion gate formed by the output electrode arrangement, wherein the ion species to be analyzed just emerges or just no longer emerges in the spectrum.

According to an advantageous embodiment, the maximum possible period duration is calculated based on the ion mobility determined via the drift time in the reference spectrum or experimentally determined via a variation of the period duration and selection of the greatest value at which interfering losses no longer occur.

According to an advantageous embodiment, the maximum total duration of the modification, thus the maximum duration occupied by the second step, is calculated based on the ion mobility determined via the drift time in the reference spectrum and the diffusion coefficients that can be calculated therefrom or experimentally determined via a variation of the duration of the second step and selection of the greatest value at which interfering losses no longer occur.

In particular the total duration of the modification can also be defined so as to be shorter on the basis of other variables, however, for example, so that a specific percentage of the ions has already been fragmented.

The values of the individual parameters from which losses occur or the resulting losses can be determined both via a variation of the parameter and measurement of the amount of charge at the detector and also via current amplifiers at the inner electrodes 28, 29 of input electrode arrangement 7 and output electrode arrangement 8. The first is implementable without additional technical expenditure, the second is helpful in particular in the period duration and the total duration of the modification, since different values of the parameters do not have to be tested out, but rather the critical point can be directly detected during the measurement.

FIG. 9 shows an ion modification area 103 similar to FIG. 7, wherein in addition electrical circuitry of the input electrode arrangement 7 and the output electrode arrangement 11 is shown. The input electrode arrangement 7 and the output electrode arrangement 8 each consist of two grid electrodes. The grid electrodes 28, 29 adjoining the modification chamber 1 in each case at the same time form the first modification electrode arrangement. An efficient generation of electrical fields in the modification chamber 1 can be generated by a skilled arrangement of switches 34 and voltage sources 30, 31, 32, by which an efficient displacement of ions in both directions and a fragmentation can be carried out using only one modification chamber 1 and a high-voltage source 32, i.e. all waveforms shown in FIG. 12 can be generated hereby. The input electrode arrangement 7 and the output electrode arrangement 8 can each additionally form an ion gate here.

According to an advantageous embodiment, as shown in FIG. 9, switches 34 exist at input electrode arrangement 7 and output electrode arrangement 11, in order to switch at least the potential of the respective innermost electrodes 28, 29. Displacements in both directions and also fragmentation can thus be efficiently implemented in only one ion modification area using a single high-voltage source 32. In addition to the circuit shown in FIG. 9, other variants are also conceivable in which, for example, the voltage sources 30, 31 are acquired from the voltage divider of the drift chambers. The integration of further switches and voltage sources is also conceivable in order to carry out additional modification steps, for example, completely without electrical fields in the ion modification area 103. Furthermore, it is advantageous to replace the switches 34 and voltage sources 30, 31, 32 by rapidly adjustable voltage sources in order to simplify the circuit.

Since the exact position of the occurrence of ions and fragments in the ion modification area 103 is unknown, additional methods for determining the mobility are advantageous. In one advantageous embodiment, the voltage is varied over the second drift chamber 11 and the respective mobility of the substances is determined from the resulting change of the drift time. For simplification, this can be carried out once in one measurement and then the time axis can be converted into a mobility axis based on the points thus known. Likewise, both the drift time and such a method can also be used in order to determine the ion mobility necessary for many calculations without modification.

FIG. 10 shows various fundamental functional principles of the ion modification area of the IMS on the basis of three diagrams. The upper diagram shows that by controlling the electrodes of the ion modification area, a fragmentation of the ions can be generated in comparison to a reference spectrum. The middle diagram shows how a displacement of ions in relation to a reference spectrum can be generated in the ion modification area. The lower diagram illustrates that filtering of the ions can also be carried out by the ion modification area. The diagrams in FIG. 10 each show the ion amount over the drift time in the drift chamber 11.

FIG. 11 illustrates an advantageous waveform of an electrical alternating field which can be used to carry out an ion modification in the ion modification area. It can be seen that in the period of time before tₛₜₐᵣₜ, no electrical field is present (field strength=0). From the time tₛₜₐᵣₜ, an electrical alternating field is generated which is switched back and forth between the limiting values E_{high} and E_{low}. The value of E_{low}<0, i.e. in this case a field strength is generated in the opposite direction to the normal drift direction. The value of E_{high} is always greater than zero. At the time tₛₜₒₚ, the ion modification by means of the electrical alternating field ends. This waveform has a constant component of zero as an electrical alternating field, but can also be overlaid with a constant component, as already mentioned.

FIG. 12 shows, on the basis of three diagrams, the electrical fields to be generated with the circuitry according to FIG. 9, for example, in the ion modification area 103 or in the modification chamber 1. The top diagram shows an advantageous application by means of an electrical alternating field, by which a fragmentation and a filtering of ions can be carried out. In this case, an alternating field symmetrical around the field strength value zero is generated. An electrical alternating field is shown in the middle diagram, for example, similarly as in FIG. 11, using which a displacement of the ions and a further filtering can be carried out. The bottom diagram shows an electrical alternating field, using which an inverted displacement and a further filtering can be carried out. In this case, the mean electrical field strength is significantly less than in the middle diagram, in particular in the middle under the field strength value zero. All of these waveforms have a constant component of zero, but can also be overlaid with a constant component, as already mentioned.

1. An ion mobility spectrometer, comprising:
at least one ion packet provision device configured to provide packets of ions in succession separated from one another at time intervals;
an ion detector;
at least one drift chamber through which ions from one or more of the packets of ions are guided over a predetermined distance in a drift direction to the ion detector, wherein the at least one drift chamber discharges the ions at the ion detector; and
an ion modification area positioned between the ion packet provision device and the at least one drift chamber, wherein the ion modification area comprises an input electrode arrangement on a first the side facing toward the ion packet provision device and an output electrode arrangement on a second side facing toward the at least one drift chamber; and a modification chamber for receiving ions arranged between the input electrode arrangement and the output electrode arrangement, wherein the ion modification area is configured to carry out one or more modifications on the ions located in the modification chamber.

2. The ion mobility spectrometer as claimed in claim 1, wherein the at least one ion packet provision device has a cyclically operated ion source and/or a continuously operated ion source.

3. The ion mobility spectrometer as claimed in claim 1 wherein the at least one ion packet provision device has a cyclically operated ion gate.

4. The ion mobility spectrometer as claimed in claim 1 further comprising a supply connection present on the ion modification area configured to introduce at least one further substance, into the modification chamber.

5. The ion mobility spectrometer as claimed in claim 4, further comprising an outlet connection present on the ion modification area opposite to the supply connection, wherein the outlet connection is configured to discharge the at least one further substance supplied via the supply connection from the modification chamber.

6. The ion mobility spectrometer as claimed in claim 1 further comprising a first modification electrode arrangement, by which an electrical field parallel to a drift direction of the ions is generatable in the modification chamber.

7. The ion mobility spectrometer as claimed in claim 6, wherein the first modification electrode arrangement is entirely or partially formed by one or more electrodes of the input electrode arrangement and/or the output electrode arrangement.

8. The ion mobility spectrometer as claimed in claim 6 wherein the first modification electrode arrangement is present in the modification chamber, wherein the first modification electrode comprises at least one electrode spaced apart from the input electrode arrangement and the output electrode arrangement, wherein the modification chamber is divided by the first modification electrode arrangement into at least one first partial chamber facing toward the input electrode arrangement and at least one second partial chamber facing toward the output electrode arrangement.

9. The ion mobility spectrometer as claimed in claim 6 further comprising a second modification electrode arrangement present at the ion modification area configured to generate in the modification chamber an electrical field orthogonal to the drift direction of the ions.

10. The ion mobility spectrometer as claimed in claim 1 wherein an extension of the modification chamber or partial chambers facing toward an input electrode arrangement or an output electrode arrangement in the direction of the drift movement of the ions corresponds to at least one times a value of a full width at half maximum of the ion packet of the ions to be analyzed.

11. A method for analyzing substances by ion mobility spectrometry by means of an ion mobility spectrometer as claimed in claim 1 comprising modifying ions in the modification chamber by one or more of modification types I), II), III), IV), and V), before the ions are moved through the drift chamber to the ion detector:
I) displacing at least one species from the ions present in a direction deviating from the drift direction,
II) reducing or increasing a drift speed of at least one species from the ions present in the drift direction or displacing at least one species from the ions present in the drift direction,
III) reducing or dissolving a cluster formation of the ions and molecules,
IV) fragmenting the ions, and
V) promoting chemical reactions and/or cluster formation of the ions.

12. The method as claimed in claim 11, wherein one or more of the modification types I), II), III), IV), and V) are at least partially carried out by generating an electrical alternating field in the modification chamber.

13. The method as claimed in claim 11 further comprising preparing the ions for modification in the modification chamber by generating initially an electrical field having a constant in the ion modification area sufficient to move modified ions from a direction of an input electrode arrangement into the modification chamber, and then, when sufficient ions are located in the modification chamber,
the constant component of the electrical field is reduced to zero, or
by adjusting the constant component of the electrical field, a movement of at least one ion species to be modified, arising due to a superimposed electrical alternating field in the modification chamber is canceled out, or
by adjusting the constant component of the electrical field, an average movement of all ion species arising due to a superimposed electrical alternating field in the modification chamber is minimized.

14. The method as claimed in claim 11 wherein one or more of the modification types I), II), III), IV), and V) are at least partially carried out by heating an interior of the modification chamber and/or the ions located in the interior of the modification chamber.

15. The method as claimed in claim 11 wherein one or more of the modification types I), II), III), IV), and V) are at least partially carried out by adding a further substance through a supply connection into the modification chamber.

16. The method as claimed in claim 15, wherein the further substance is a substance to be analyzed by ion mobility spectrometry, wherein the further substance is supplied so as to form analyte ions to be analyzed with ions provided by the ion packet provision device and transported into the modification chamber.

17. The method as claimed in claim 11 further comprising alternately recording an ion mobility spectra with and without modification of the ions in the modification chamber.

18. The ion mobility spectrometer of claim 4 wherein the at least one further substance is a gaseous substance.

19. The ion mobility spectrometer of claim 7 wherein the first modification electrode arrangement is formed by electrodes of one or more of the input electrode arrangement and output electrode arrangement closest to the modification chamber.

20. The method of claim 12 wherein the alternating electrical field is asymmetrical or symmetrical.
